(19) United States
(12) Patent Application Publication
(10) Pub. No.: US 2006/0282434 A1
(43) Pub. Date: Dec. 14, 2006

(54) Access to fragmented database system

(75) Inventor: Kari Einamo, Suinula (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/245,107

(22) Filed: Oct. 7, 2005

(30) Foreign Application Priority Data
Jun. 13, 2005 (EP) 05012680.4

(51) Int. Cl. G06F 17/30

(52) U.S. Cl. 707/10

(57) ABSTRACT

A distributed database system returns a token which an application may use in consecutive requests to the distributed database system to by-pass a fragmentation layer or distribution functionality of the distributed database system.

### FIELD OF THE INVENTION

The present invention relates to accessing a fragmented database system. In particular, the invention relates to accessing a database system comprising a distributed database including database fragments, and a distributing unit for forwarding a request from an application to the distributed database to a database fragment holding information indicated in the request.

### BACKGROUND OF THE INVENTION

Fragmented databases are used to provide a required amount of storage capacity. A fragmented database (DB) is a solution having a group of independent databases typically running on separate servers. A distribution/fragmentation functionality is required that knows in which fragment of the distributed database a certain piece of information is stored.

Fragmented DB systems are typically used when clustered COTS (Commercial Off-The-Shelf) databases like Oracle cannot provide enough performance, are too expensive compared to the required functionality or there is need to have different types of storage media in one DB system, like disk databases, In-Memory-databases, files, and LDAP (Lightweight Directory Access Protocol) databases.

In the distributed database system the distributor function easily becomes a bottleneck of the system, especially if all requests have to pass that function. The distribution function has to be contacted every time a data access interface is session-less, i.e. in case each request is independent from earlier requests.

In the prior art this problem is solved by providing enough capacity in the distribution functionality.

### SUMMARY OF THE INVENTION

The present invention is made to optimize an access to a fragmented database system, thereby enhancing scalability.

This is achieved by a device according to claim 1.

Furthermore, this is achieved by a distributed database according to claim 5.

Furthermore, this is achieved by a distributing unit according to claim 9.

Furthermore, this is achieved by a device according to claim 13.

Furthermore, this is achieved by an application device according to claim 14 and a method according to claim 19.

In addition, this is achieved by a method of accessing a distributed database according to claim 16.

The present invention can also be implemented as a computer program product which may comprise a computer-readable medium and/or may be directly loadable into an internal memory of a computer.

It is an advantage of the invention to lessen scalability requirements of the designed bottleneck, therefore ensuring better overall scalability at lower costs.

### BRIEF DESCRIPTION OF THE DRAWINGS

FIG. 1 shows a schematic block diagram illustrating an arrangement of a distributed database system, an interfacing unit and an application unit according to an embodiment of the invention.

FIG. 2 shows a flow chart illustrating an operation of the database system and interfacing unit of FIG. 1 according to an embodiment of the invention.

FIG. 3 shows a flow chart illustrating an operation of the database system and distributing unit of FIG. 1 according to another embodiment of the invention.

FIG. 4 shows a flow chart illustrating an operation of the application unit of FIG. 1.

FIG. 5 shows a schematic diagram illustrating data flows between an application and a distributed database system according to the invention.

### DESCRIPTION OF THE PREFERRED EMBODIMENTS

The idea of the invention is that a distributed database system returns a token which an application may use in consecutive requests to the distributed database system to by-pass a fragmentation layer or distribution functionality of the distributed database system.

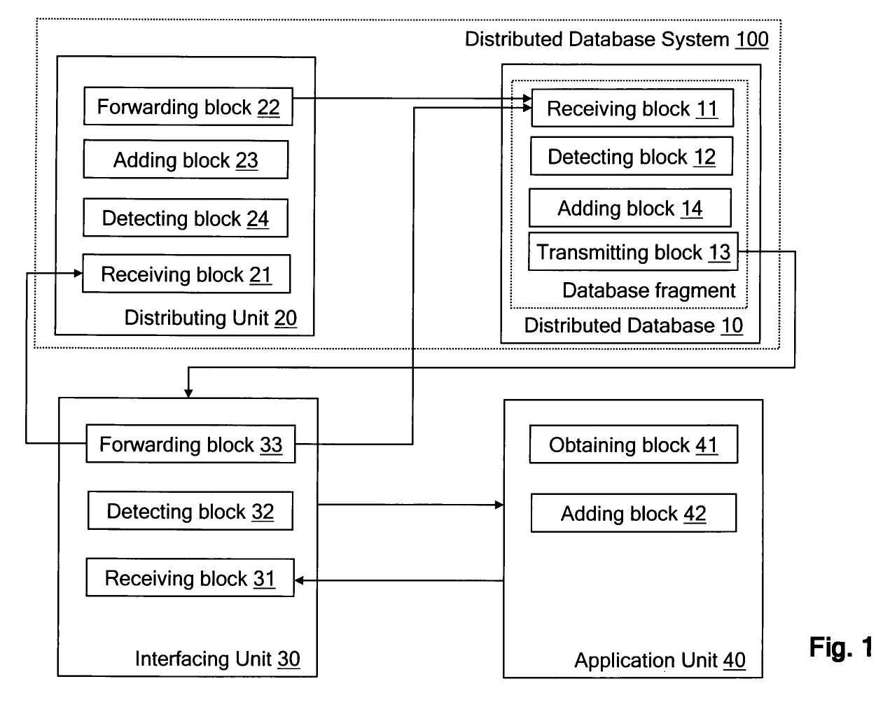

FIG. 1 shows a schematic block diagram illustrating an arrangement of a distributed database system 100, an interfacing unit 30 and an application unit 40 according to an embodiment of the invention. The distributed database system 100 comprises a distributing unit 20 performing distribution functionality knowing in which database fragment a certain piece of information is stored, and a distributed database 10 comprising database fragments holding information. The database fragments of the distributed database 10 may run on different servers. The distributing unit 20 may comprise a record indicating which data is stored in which database fragment for performing distribution functionality.

The distributing unit 20 is for forwarding a request issued e.g. from an application towards the distributed database 10 to a database fragment holding requested information indicated in the request. A token for the request forwarded by the distributing unit 20 then is returned to the application, the token indicating the database fragment holding the requested information.

The distributing unit 20 comprises a receiving block 21 for receiving the request from the application to the distributed database 10, and a forwarding block 22 for forwarding the request to the database fragment holding the requested information indicated in the request. The distributing unit 20 may further comprise an adding block 23 for adding the token for the request, the token indicating the database fragment holding the requested information. The forwarding block 22 may forward the request on the basis of a record indicating which data is stored in which database fragment.

The distributing unit 20 may further comprise a detecting block 24 for detecting whether the request includes a token indicating the database fragment holding the requested information indicated in the request. The forwarding block 22 then forwards the request to the database fragment on the basis of the token in case the token is detected to be included in the request by the detecting block 24, and forwards the request to the database fragment holding requested information indicated in the request on the basis of the record indicating which data is stored in which database fragment otherwise. In case the token is detected to be not included in the request by the detecting block 24, the adding block 23 may add the token for the request.

The distributed database 10 comprises database fragments for holding information. Each database fragment of the distributed database 10 comprises a receiving block 11 for receiving a request issued from an application towards the distributed database 10, a detecting block 12 for detecting that the request is forwarded by the distributing unit 20 to the database fragment holding the requested information indicated in the request, and a transmitting block 13 for returning to the application a token for the request forwarded by the distributing unit 20, the token indicating the database fragment holding the requested information. The transmitting block 13 may return the token to the application together with data read out from the database fragment according to the requested information. The database fragment may further comprise an adding block 14 for adding the token for the request.

In addition or alternatively, the detecting block 12 may detect whether or not the request includes the token indicating the database fragment holding requested information, the transmitting block 13 returning the token with a response message for the request, when it is detected by the detecting block 12 that the request does not include the token.

The application unit 40 for running the application comprises an obtaining block 41 for obtaining the token from the distributed database system 100 via the interfacing unit 30. The obtaining block 41 may obtain the token from a response from the distributed database 10, which includes data read out from the database fragment according to the requested information. The application unit 40 further comprises an adding block 42 for adding the token to a following request to the distributed database, the following request being based on the requested information, i.e. when re-accessing data of the database fragment. The application unit 40 may store a relationship between received tokens and accessed data e.g. in a table. The complexity of a mapping structure depends e.g. on how many simultaneous entries the application unit 40 wants to keep and how fast that information has to be accessed. In simple cases no table is needed but just a local variable is used. In more complex cases some kind of a hash structure may be used.

The interfacing unit 30 is for interfacing the application running on the application unit 40 and the database system 10. The interfacing unit 30 comprises a receiving block 31 for receiving a request from the application to the distributed database 10, a detecting block 32 for detecting whether the request includes a token indicating the database fragment holding the requested information indicated in the request, and a forwarding block 33 for forwarding the request to the database fragment on the basis of the token in case the token is detected to be included in the request by the detecting block 32, and forwarding the request to the distributing unit 20 otherwise.

Alternatively, the interfacing unit 30 may forward the request to the distributing unit 20 regardless of whether a token is included in the request or not, in which case the distributing unit 20 checks the existence of the token as described above.

The distributing unit 20, the interfacing unit 30 and the application unit 40 may be implemented as digital signal processors or application specific integrated circuits. It is to be noted that the invention is not limited to the arrangement of the blocks in the units as shown in FIG. 1. For example, the receiving and forwarding/transmitting blocks may be grouped together into one transceiver block in each unit.

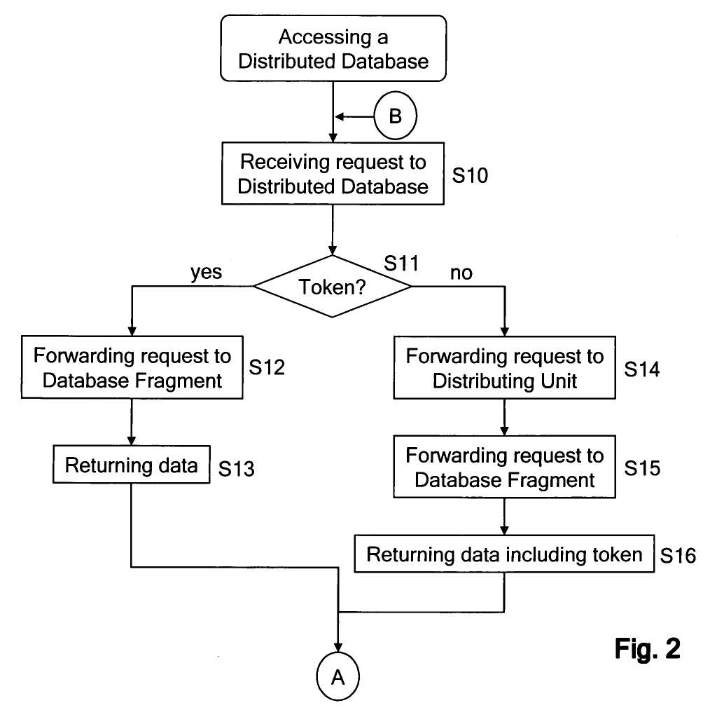

FIG. 2 shows a flow chart illustrating an operation of the database system 100 and the interfacing unit 30 shown in FIG. 1.

In particular, FIG. 2 illustrates a procedure of accessing the distributed database 10. In step S10 a request from an application to the distributed database is received by the interfacing unit 30. The interfacing unit 30 detects in step S11 whether the request includes a token indicating a database fragment of the distributed database 10, holding requested information indicated in the request. If YES in step S11, the interfacing unit 30 forwards the request directly to the database fragment on the basis of the token in step S12. The accessed database fragment returns data read out from the database fragment according to the requested information in step S13.

However, if NO in step S11, the request is forwarded to the distributing unit 20 in step S14. In step S15 the request is forwarded from the distributing unit 20 to the database fragment holding the requested information indicated in the request. According to forwarding the request via the distributing unit, in step S16 the token indicating the database fragment holding the requested information is returned to the application.

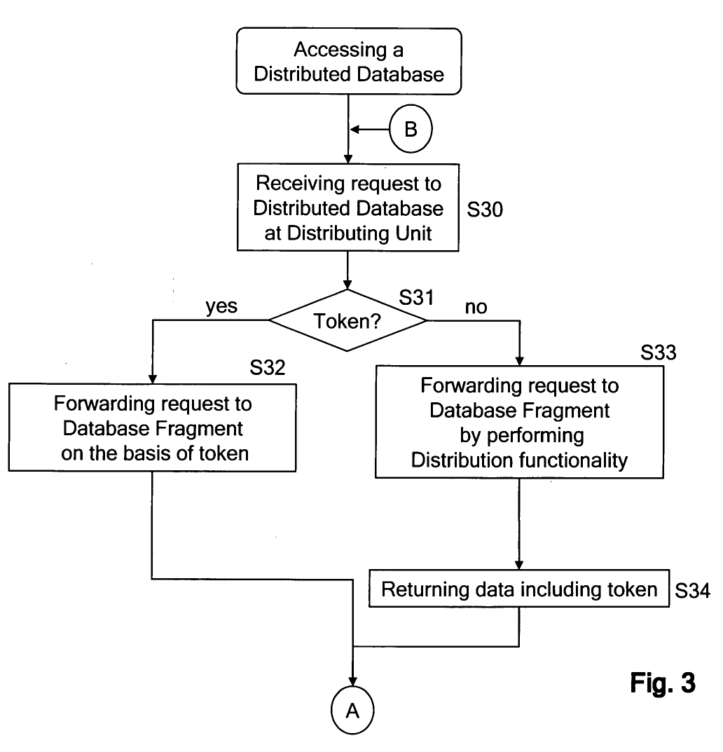

FIG. 3 shows a flow chart illustrating an operation of the database system and distributing unit of FIG. 1 according to another embodiment of the invention.

FIG. 3 illustrates a procedure of accessing the distributed database 10. In step S30 a request towards the distributed database is received by the distributing unit 20. In step S31 it is detected in the distributing unit 20 whether the request includes a token indicating the database fragment holding requested information indicated in the request. In case it is decided in step S31 that the token is included in the request, the request is forwarded to the database fragment on the basis of the token in step S32.

In case it is decided in step S31 that the token is not included in the request, in step S33 the request is forwarded to the database fragment holding the requested information indicated in the request on the basis of a record indicating which data is stored in which database fragment. Then in step S34 the token indicating the database fragment holding the requested information is returned to the application.

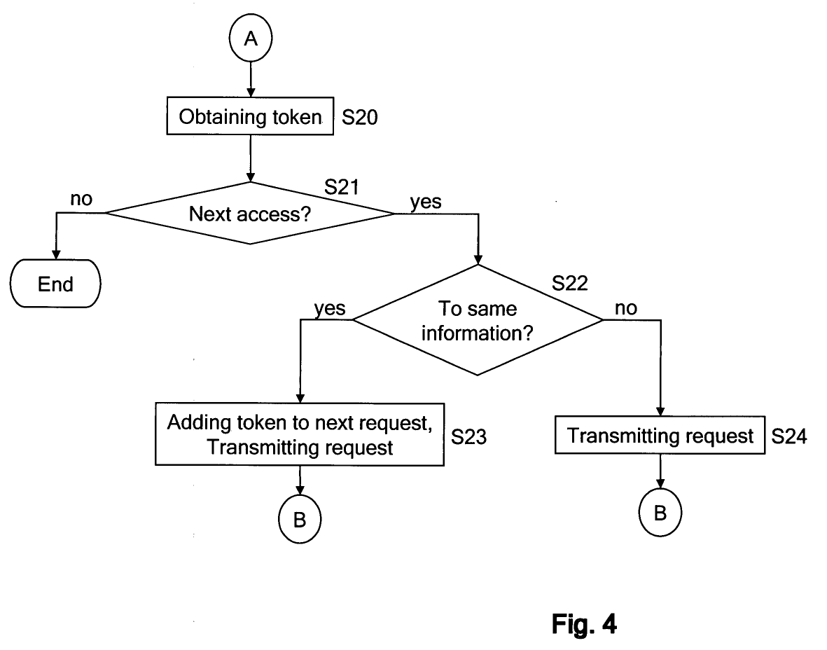

FIG. 4 shows a flow chart illustrating an operation of the application unit 40 shown in FIG. 1.

In step S20 the application unit 40 running the application receives a response to the request to the distributed database 10, and obtains the token returned in step S16 in FIG. 2 or step S34 in FIG. 3. In step S21 it is determined in the application unit 40 whether a further access to the distributed database is to be made. If YES in step S21, it is determined whether same information as in the previous request is to be accessed in step S22. If NO in step S21, the process flow ends. If YES in step S22, the application unit 40 adds the obtained token to a following request to the distributed database 10 in step S23. If NO in step S21, no token is added to the request to the distributed database 10 as indicated in step S24.

The application unit 40 may store tokens against requested information held in the distributed database 10. Thus, in step S22 it may be determined whether same information as in any previous request is to be accessed, and in step S23 the token corresponding to information accessed in the previous request is added.

According to the embodiment of the invention shown in FIGS. 2 and 4, when the distributed database 10 is accessed for the first time, the request is forwarded through the distributing unit 20 which forwards the request to the database fragment or server of the database fragment where the requested information is stored. In the feedback signalling the token is added to a message responding to the request. The application running on the application unit 40 may then access the database fragment of the distributed database 10 directly, omitting the distributing unit 20, by adding the token to the request signalling. The token may be an integer value.

According to the embodiment of the invention shown in FIGS. 3 and 4, the request is forwarded through the distributing unit 20 in any case, but the distributing unit 20 performs distribution functionality only in case the token is not included in the request.

According to an implementation example, the token may be generated in a database access layer of a database fragment server, and may be returned to the application with actual database query results. The token includes a database fragment/server indication. The application using a database system application program interface does not have to know the content of the token, it is sufficient that the token is returned back to the database system in consecutive requests.

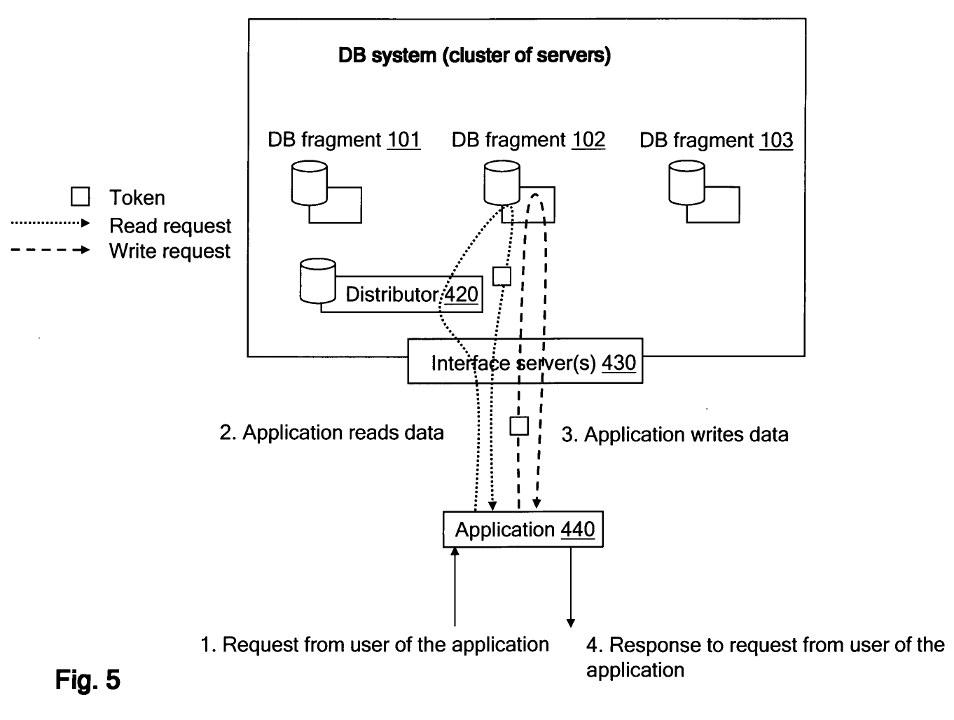

FIG. 5 shows a schematic diagram illustrating data flows between an application and a distributed database system according to the invention.

As shown in FIG. 5, a distributed database includes database fragments 101, 102 and 103. When an application 440 receives a request from a user of the application (communication 1 in FIG. 5), it issues a read request towards the distributed database via an interface server 430, for reading data in accordance with the read request. The interface server 430 may be part of a plurality of interface servers providing an interface to the distributed database comprising the database fragments 101-103. As the read request issued by the application 440 is a first access to the data and thus does not include a token indicating one of the database fragments or servers 101-103, the interface server 430 forwards the read request to a distributor 420 which incorporates a distribution/fragmentation functionality that is aware of which fragment 101-103 stores the data to be read. The distributor 420 then forwards the read request to the database fragment 102 storing the data to be read. In a response message transmitted to the application 440 via the interface server 430, the database fragment 102 returns a token indicating the database fragment/server 102 together with the data read from the database fragment. The data flow according to the read request from the application 440 to the database fragment 102 via the interface server 430 and the distributor 420 and from the database fragment 102 back to the application 440 via the interface server 430 is represented by a communication 2 in FIG. 5.

The application 440 performs processing on the basis of the read data, e.g. updates the read data. After that the application 440 may want to store the updated data back. Therefore, the application 440 issues a write request towards the distributed database via the interface server 430. Since in the write request the data of the database fragment 102 is to be accessed a second time, the application 440 adds the token received in the response message from the database fragment 102 to the write request. The interface server 430 detects the token in the write request and forwards the write request directly to the database fragment 102. Thus, the write request does not go via the distributor 420 since the token identifies the target fragment. Moreover, as the write request is forwarded directly from the interface server 430, the database fragment 102 does not return a (further) token to the application 440. The data flow according to the write request from the application 440 to the database fragment 102 via the interface server 430 and back to the application 440 via the interface server 430 is represented by a communication 3 in FIG. 5. Finally, in a communication 4 in FIG. 5 a response to the request from the user of the application 440 is issued by the application 440.

The application 440 may run on the application unit 40 of FIG. 1, and the interface server 430 and the distributor 420 may by similarly arranged as the interfacing unit 30 and the distributing unit 20 of FIG. 1. The database fragments 101-103 may have a similar structure as the database fragment shown in FIG. 1, i.e. the distributed database 10 may include the database fragments 101-103.

It is to be understood that the above description is illustrative of the invention and is not to be construed as limiting the invention. Various modifications and applications may occur to those skilled in the art without departing from the true spirit and scope of the invention as defined by the appended claims.

1. A device comprising:
a distributed database comprising database fragments for holding information; and
a distributing unit for forwarding a request issued towards the distributed database and received by said device to a database fragment holding requested information indicated in the request,
wherein a token for the request forwarded by the distributing unit is returned with a response message for the request, the token indicating the database fragment holding the requested information.

2. The device according to claim 1, wherein the database fragment holding the requested information is configured to add the token for the request.

3. The device according to claim 1, wherein the distributing unit is configured to add the token for the request.

4. The device according to claim 1, wherein the database fragment is configured to return the token with the response message for the request together with data read out from the database fragment according to the requested information.

5. A distributed database comprising database fragments for holding information, a database fragment comprising:
receiving means for receiving a request towards the distributed database;
detecting means for detecting that the request is forwarded by a distributing unit to the database fragment holding requested information indicated in the request; and
transmitting means for returning a token for the request, when it is detected by the detecting means that the request is forwarded by the distributing unit, the token indicating the database fragment holding the requested information.

6. The distributed database according to claim 5, wherein
said detecting means is configured to detect whether or not the request received by said receiving means includes a token indicating the database fragment holding requested information, and
said transmitting means is arranged to return the token with a response message for the request, when it is detected by the detecting means that the request does not include the token.

7. The distributed database according to claim 5, wherein the database fragment further comprises adding means for adding the token for the request.

8. The distributed database according to claim 5, wherein the transmitting means is configured to return the token together with data read out from the database fragment according to the requested information.

9. A distributing unit for processing requests to a distributed database comprising database fragments holding information, the distributing unit comprising:
receiving means for receiving a request towards the distributed database;
forwarding means for forwarding the request to a database fragment holding requested information indicated in the request; and
adding means for adding a token for the request, the token indicating the database fragment holding the requested information.

10. The distributing unit according to claim 10, wherein the forwarding means is configured to forward the request on the basis of a record indicating which data is stored in which database fragment.

11. The distributing unit according to claim 9, comprising:
detecting means for detecting whether the request includes a token indicating a database fragment holding requested information indicated in the request,
wherein the forwarding means is configured to forward the request to the database fragment on the basis of the token in case the token is detected to be included in the request by the detecting means, or to forward the request to the database fragment holding requested information indicated in the request on the basis of a record indicating which data is stored in which database fragment.

12. The distributing unit according to claim 11, further comprising adding means for adding the token for the request, the token indicating the database fragment holding the requested information, in case the token is detected to be not included in the request by the detecting means.

13. A device for interfacing an application and a database system having a distributed database including database fragments holding information, and a distributing unit for forwarding a request issued from the application towards the distributed database to a database fragment holding requested information indicated in the request, the device comprising:
receiving means for receiving the request from the application;
detecting means for detecting whether the request includes a token indicating the database fragment holding the requested information indicated in the request; and
forwarding means for forwarding the request to the database fragment on the basis of the token in case the token is detected to be included in the request by the detecting means, or for forwarding the request to the distributing unit.

14. An application device for running an application, comprising:
obtaining means for obtaining a token, which indicates a database fragment holding requested information indicated in a request issued from the application towards a distributed database including database fragments comprising the database fragment holding the requested information, from a response to the request; and
adding means for adding the token to a following request to the distributed database, the following request being based on the requested information.

15. The application device according to claim 14, wherein the obtaining means is configured to obtain the token from the response which includes data read out from the database fragment according to the requested information.

16. A method of accessing a distributed database comprising database fragments, comprising:
a receiving step of receiving a request to the distributed database;
a detecting step of detecting whether the request includes a token indicating a database fragment holding requested information indicated in the request;
a first forwarding step of forwarding the request to the database fragment on the basis of the token in case the token is detected to be included in the request in the detecting step.

17. The method according to claim 16, wherein in the first forwarding step the request is forwarded to a distributing unit in case the token is detected to be not included in the request in the detecting step, the method comprising
a second forwarding step of forwarding the request forwarded to the distributing unit from the distributing unit to the database fragment holding the requested information indicated in the request.

18. The method according to claim 17, the method further comprising:
a returning step of returning the token indicating the database fragment holding the requested information in case the request is forwarded to the database fragment in the second forwarding step.

19. A method of running an application, comprising:
an obtaining step of obtaining a token, which indicates a database fragment holding requested information indicated in a request from the application to a distributed database including database fragments comprising the database fragment holding the requested information, from a response to the request; and
an adding step of adding the token to a following request to the distributed database, the following request being based on the requested information indicated in the request.

20. A computer program product embodied on a computer readable medium, the computer program product comprising software code portions for performing the steps of:
a receiving step of receiving a request to a distributed database;
a detecting step of detecting whether the request includes a token indicating a database fragment holding requested information indicated in the request;
a first forwarding step of forwarding the request to the database fragment on the basis of the token in case the token is detected to be included in the request in the detecting step.

21. A computer program product embodied on a computer readable medium, the computer program product comprising software code portions for performing the steps of:
an obtaining step of obtaining a token, which indicates a database fragment holding requested information indicated in a request from a application to a distributed database including database fragments comprising the database fragment holding the requested information, from a response to the request; and
an adding step of adding the token to a following request to the distributed database, the following request being based on the requested information indicated in the request.
